(19) United States
(12) Patent Application Publication
(10) Pub. No.: US 2005/0237643 A1
(43) Pub. Date: Oct. 27, 2005

(54) MIRROR OF MOTORCYCLE WITH SWIVEL MOUNT

(76) Inventor: Hsiu-Li Wu, Tainan Hsien (TW)

Correspondence Address: BIRCH STEWART KOLASCH & BIRCH, PO BOX 747, FALLS CHURCH, VA, 22040-0747, US

(21) Appl. No.: 10/829,981

(22) Filed: Apr. 23, 2004

(51) Int. Cl. G02B 1/00; G02B 7/182

(52) U.S. Cl. 359/871; 359/879

(57) ABSTRACT

A mirror assembly of motorcycle is disclosed. The assembly comprises an arm mechanism including an arm secured to a handlebar, and a bore on the top end; a mirror mechanism including a threaded hole on a bottom of a connecting member thereof; and a universal joint mechanism including a ring-shaped seat secured to the threaded hole, and a post having a top ball, the ball being substantially enclosed by the mirror mechanism and the seat and pivotably supported on the seat when the post is inserted through the seat into the bore for fastening. The mirror mechanism is operative to either turn freely about the ball on a horizontal plane or turn about the ball on a vertical plane in a limited angle.

### FIELD OF THE INVENTION

The present invention relates to mirrors of a motorcycle and more particularly to either mirror of a motorcycle that allows a free turning in a horizontal direction and a limited swing in a vertical direction so as to increase driving safety by reducing dead angle.

### BACKGROUND OF THE INVENTION

Conventionally, a motorcycle has left and right mirrors as required by the laws. A driver may look at left and/or right mirrors for observing vehicles at left rear, right rear, or any other directions while driving. As such, the driving can be made safer. Further, the mirrors can be used for adjusting personal adornment. However, a dead angle may occur if the driver changes his/her body orientation. Thus, it is typical for a driver to adjust the mirror(s) due to vibration and/or deflection in addition to the above reason. A conventional right mirror assembly mounted on a motorcycle is shown in FIG. 1. The mirror assembly comprises a support fixed to a handlebar, an arm extended from the support, and a mirror formed on top of the arm. A driver may adjust the mirror for obtaining an optimum view by swinging a limited angle as indicated by dash lines.

However, the prior art design suffered from a disadvantage. For example, the arm and the mirror are formed integrally. Thus, a driver has to turn both the arm and the mirror for angle adjustment. In an undesired case, the mirror may be broken or the adjustment is excessive (i.e., larger dead angle) if the exerted force is excessively large. Hence, a need for improvement exists.

### SUMMARY OF THE INVENTION

It is an object of the present invention to provide a mirror of motorcycle that allows a free turning in a horizontal direction and a limited swing in a vertical direction so that a driver may easily adjust left and/or right mirrors and observe vehicles at left rear, right rear, or any other directions while driving. As such, the driving can be made safer.

It is another object of the present invention to provide an aesthetic and practical mirror of motorcycle in which an arcuate frame is formed around the edge and the rear of a mirror so as to prevent rain from accumulating on the mirror, preserve the mirror's appearance, reduce dead angle, and thus increase driving safety.

To achieve the above objects, the present invention provides a mirror assembly of a motorcycle, comprising an arm mechanism including an arm having a threaded member at a bottom end, the threaded member being secured to a handlebar, an arcuate projection at a side of a top flat end, a bore on the top end, and a conic section on a mouth of the bore; a mirror mechanism including a connecting member at an inner side, and a second arcuate projection on a side surface of the connecting member, the second arcuate projection being disposed corresponding to the first arcuate projection; and a universal joint mechanism including a ring-shaped seat secured to a bottom of the connecting member, and a post having a top ball, the ball being substantially enclosed by the mirror mechanism and the seat and pivotably supported on the seat when the post is inserted through the seat into the bore for fastening the universal joint mechanism and the arm mechanism together; wherein the mirror mechanism is operative to either turn about the ball on a horizontal plane in an angle ranged from 0 degree to 360 degrees or turn about the ball on a vertical plane in an angle ranged from 0 degree to a predetermined degree. By utilizing the present invention, advantages of providing an optimum angle adjustment of the mirror, reducing dead angle, and increasing driving safety can be obtained.

The above and other objects, features and advantages of the present invention will become apparent from the following detailed description taken with the accompanying drawings.

### BRIEF DESCRIPTION OF THE DRAWINGS

FIG. 1 is a perspective view of a conventional right mirror mounted on a motorcycle;

FIG. 2 is an exploded view of a mirror assembly of motorcycle according to the invention;

FIG. 3 is a perspective view of the assembled mirror assembly;

FIG. 4 is a sectional view of the mirror assembly shown in FIG. 3;

FIG. 5 is a view similar to FIG. 4 for illustrating a limited swing of the mirror on a vertical plane; and

FIG. 6 is a view similar to FIG. 3 for illustrating a free turning of the mirror on a horizontal plane.

### DETAILED DESCRIPTION OF THE PREFERRED EMBODIMENTS

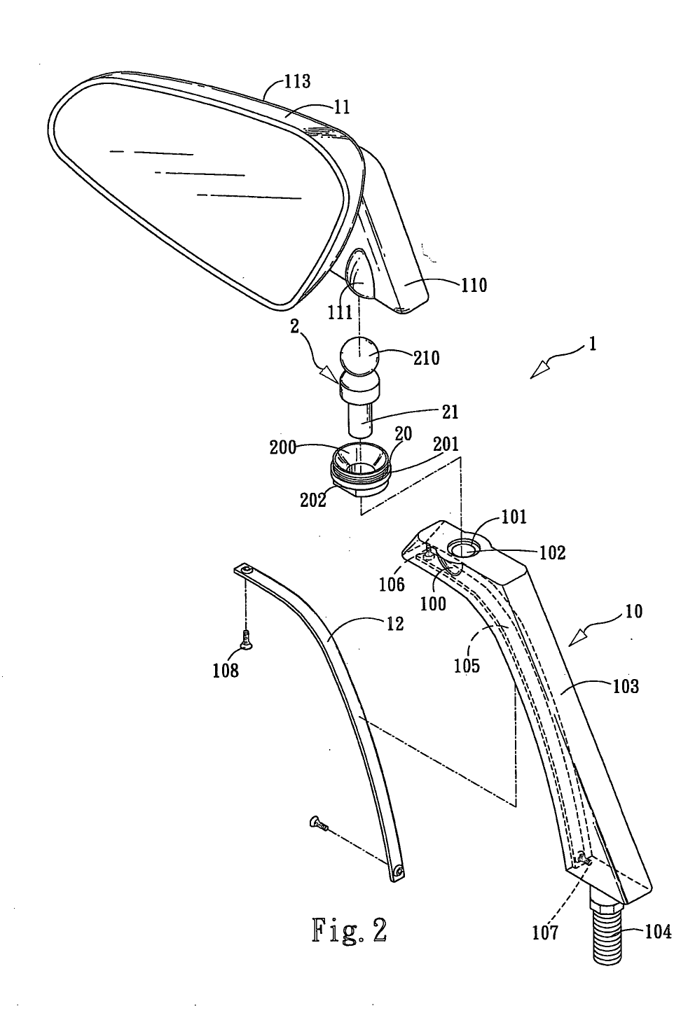

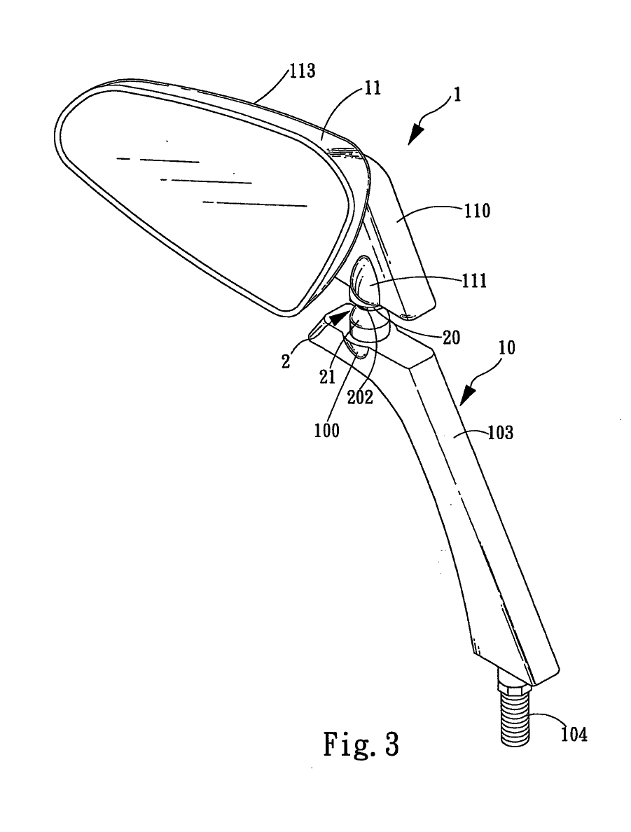

Referring to FIGS. 2 and 3, a mirror assembly 1 of motorcycle constructed in accordance with the invention is shown. The mirror assembly 1 comprises an arm mechanism 10, a mirror mechanism 11, and a universal joint mechanism 2. Each component will be described in detail below.

The arm mechanism 10 comprises an arm 103 having a threaded post 104 at a bottom end, an arcuate projection 100 at a side of a top flat end, a hole 102 on the top end, a conic section 101 on the mouth of the hole 102, a groove 105 on an inner surface extended from the top end to the bottom end, two threaded holes 106 and 107 at both ends of the groove 105, and an aesthetic elongated member 12 snugly secured to the groove by driving fasteners (e.g., screws) 108 through the elongated member 12 into the threaded holes 106 and 107. Such can preserve the arm mechanism's appearance.

The mirror mechanism 11 comprises a connecting member 110 at an inner side, an arcuate projection 111 on a side surface of the connecting member 110, the arcuate projection 111 being disposed corresponding to the arcuate projection 100, a threaded hole 112 on a bottom of the connecting member 110 adjacent the arcuate projection 111, and an arcuate frame 113 around the rear of a mirror, the frame 113 being adapted to prevent rain from accumulating on the mirror mechanism 11.

The universal joint mechanism 2 comprises a ring-shaped seat 20 including an upper section 201 having outer threads, a conic section 201 on the mouth, and two opposite flats 202 on a lower section, the provision of the flats 202 being for permitting a tool to hold and turn itself; and a separate post 21 having a top ball 210 in which the ball 210 is pivotably supported on the conic section 201 when the post 21 is inserted through the seat 20 into the hole 102 for fastening.

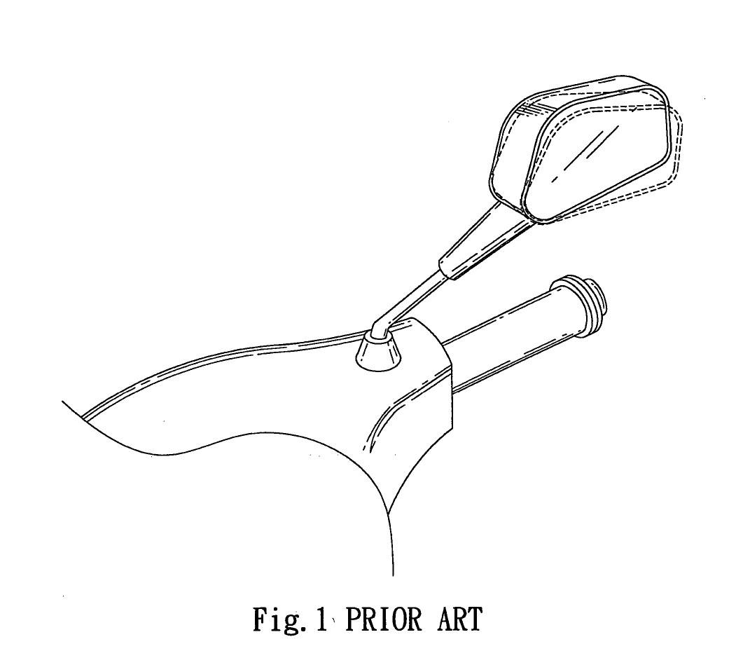

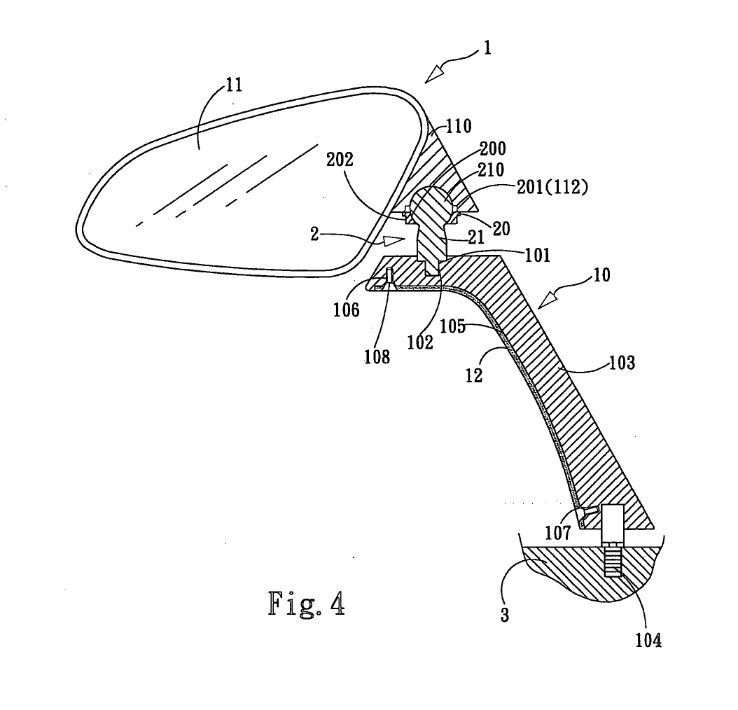

Referring to FIG. 4 in conjunction with FIGS. 1 and 2, an assembly of the mirror assembly 1 of the invention will now be described in detail below. The universal joint mechanism 2 is mounted to interconnect the mirror mechanism 11 and the arm mechanism 10. Insert the post 21 through the seat 20 into the hole 102 for fastening at the arm mechanism 10 with the ball 210 being pivotably supported on the conic section 201. Next, secure the threaded section 201 to the threaded hole 112. As shown, the ball 210 is substantially enclosed by the mirror mechanism 11 and the seat 20. Finally, secure the threaded post 104 (i.e., the arm mechanism 10) to the handlebar 3 of the motorcycle.

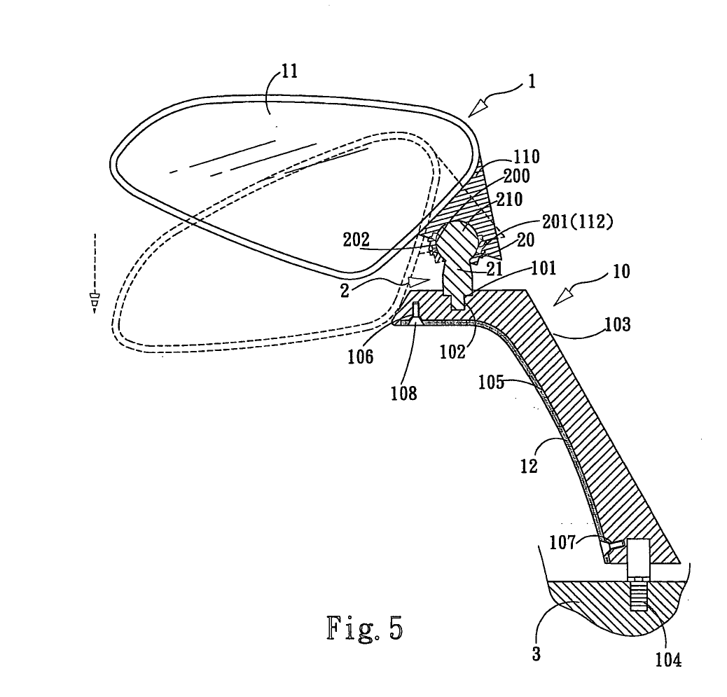

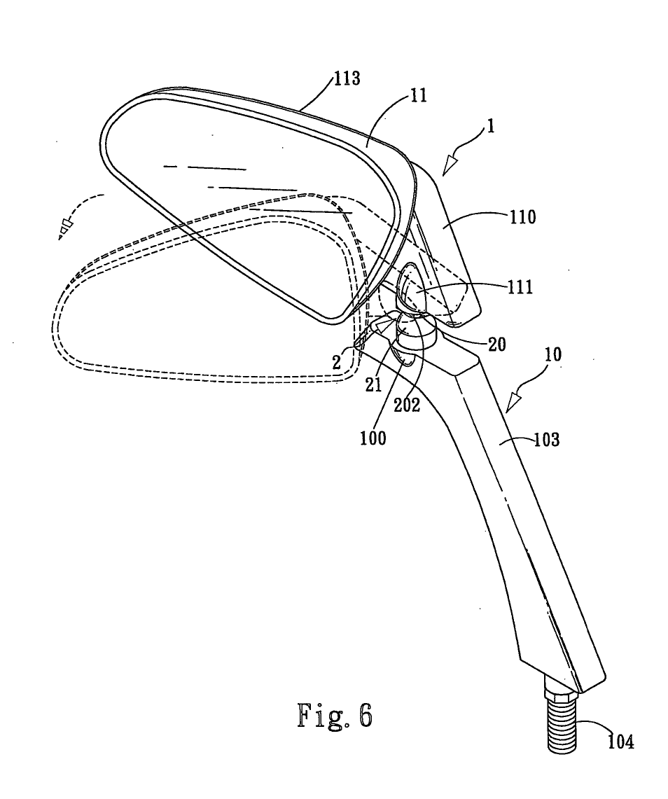

Referring to FIGS. 5 and 6, an angle adjustment of the mirror assembly 1 of the invention will now be described in detail below. A driver may use the hand to turn the mirror mechanism 11 with respect to the ball 210. This can carry out a free turning of the mirror mechanism 11 on a horizontal plane (see FIG. 6). Also, the driver may pivot the mirror mechanism 11 about the ball 210 so as to carry out a limited swing of the mirror mechanism 11 on a vertical plane as shown in FIG. 5. By operating as above, a driver can adjust the mirror mechanism 11 for obtaining an optimum view in observing vehicles at left rear, right rear, or any other directions while driving.

In brief, the characteristics of the invention are that the post 21 is inserted into the hole 102 for securing the universal joint mechanism 2 to the arm mechanism 10. The threaded section 201 is secured to the threaded hole 112 (i.e., the universal joint mechanism 2 is secured to the arm mechanism 10). The seat 11 is thus able to pivot about the ball 210 for performing a free turning in a horizontal direction or a limited swing in a vertical direction. It will be evident from the foregoing that the invention has the following the advantages of providing an optimum angle adjustment of the mirror, reducing dead angle, and thus increasing driving safety.

While the invention herein disclosed has been described by means of specific embodiments, numerous modifications and variations could be made thereto by those skilled in the art without departing from the scope and spirit of the invention set forth in the claims.

1. A mirror assembly of a motorcycle, comprising:
an arm mechanism including an arm having a threaded member at a bottom end, the threaded member being secured to a handlebar, an arcuate projection at a side of a top flat end, a bore on the top end, and a conic section on a mouth of the bore;
a mirror mechanism including a connecting member at an inner side, and a second arcuate projection on a side surface of the connecting member, the second arcuate projection being disposed corresponding to the first arcuate projection; and
a universal joint mechanism including a ring-shaped seat secured to a bottom of the connecting member, and a post having a top ball, the ball being substantially enclosed by the mirror mechanism and the seat and pivotably supported on the seat when the post is inserted through the seat into the bore for fastening the universal joint mechanism and the arm mechanism together;
wherein the mirror mechanism is operative to either turn about the ball on a horizontal plane in an angle ranged from 0 degree to 360 degrees or turn about the ball on a vertical plane in an angle ranged from 0 degree to a predetermined degree.

2. The mirror assembly of claim 1, wherein the arm mechanism further comprises a groove on an inner surface, two threaded holes at both ends of the groove, and an elongated member threadedly secured to the groove by driving fasteners through the elongated member into the threaded holes.

3. The mirror assembly of claim 1, wherein the mirror mechanism further comprises an arcuate frame around its rear.

4. The mirror assembly of claim 1, wherein the connecting member comprises a threaded hole on a bottom adjacent the second arcuate projection.

5. The mirror assembly of claim 1, wherein the seat comprises an upper section having outer threads, a conic section on a mouth, and two opposite flats on a lower section, the flats being adapted to permit a tool to hold and turn itself.
